(19) United States
(12) Patent Application Publication
(10) Pub. No.: US 2024/0220829 A1
(43) Pub. Date: Jul. 4, 2024

(54) METHODS AND MODULES FOR ACCELERATING INFERENCE VIA DISTRIBUTED DEVICES

(71) Applicants: Huawei Technologies Canada Co., Ltd., Kanata (CA); The Governing Council of the University of Toronto, Toronto (CA)

(72) Inventors: Chenghao Hu, Toronto (CA); Baochun Li, Toronto (CA); Zhixiang Chi, Ottawa (CA); Yuanhao Yu, Ottawa (CA); Yang Wang, Montreal (CA); Jin Tang, Ottawa (CA)

(21) Appl. No.: 18/087,897

(22) Filed: Dec. 23, 2022

(51) Int. Cl. G06N 5/04

(52) U.S. Cl. CPC G06N 5/04

(57) ABSTRACT

Methods and modules for accelerating inference computations in transformer models using edge devices includes partitioning inputs for each layer and synchronizing between transformer layers. A method includes receiving a transformer input, partitioning the transformer input into two or more first-stage divisions, processing each first-stage division into a processed first-stage division, and combining the processed first-stage divisions into a first output. A module includes a computing device for partitioning a transformer input into two or more divisions, transmitting each of the divisions, and receiving processed divisions, as well as two or more transformer processing units, each for receiving a division from the computing device, processing the division into a processed division, and sending the processed division to the computing device.

### TECHNICAL FIELD

The present disclosure pertains generally to artificial-intelligence transformers and in particular to accelerating inference in transformers using distributed devices.

### BACKGROUND

Artificial intelligence (AI) models such as deep learning models (for example, convolutional neural networks and transformers) are increasingly used in a wide variety of applications as a result of the significant development in the availability of and reductions in the costs associated with computational power. The acceleration of large deep learning models have accordingly become an area of interest for both academic and practical applications. AI models are usually trained in computational friendly environments such as server computers or cloud servers. However, practical deployment of such AI models often faces practical challenges in resource-constrained applications including computing environments lacking computing power in a centralized location such as resource-constrained servers, edge devices, and the like, and systems where providing such centralized computing power would be impractical.

### SUMMARY

In some examples of the present disclosure, methods and modules provide a transformer architecture suitable for accelerated computation with a plurality of devices such as edge devices, wherein inputs for transformers are divided and distributed among devices.

According to one aspect of this disclosure, there is provided a method comprising receiving a transformer input; partitioning the transformer input into two first-stage divisions; processing each first-stage division into a processed first-stage division; and combining the processed first-stage divisions into a first output.

In an embodiment, the step of partitioning the transformer input comprises partitioning the transformer input into three or more first-stage divisions.

In an embodiment, the method further comprises the steps of broadcasting the first-stage divisions; and broadcasting the processed first-stage divisions.

In an embodiment, the method further comprises the steps of partitioning the first output into two second-stage divisions; processing each second-stage division into a processed second-stage division; and combining the processed second-stage divisions into a second output.

In an embodiment, the step of partitioning the first output comprises partitioning the first output into three or more second-stage divisions.

In an embodiment, the method further comprises the steps of: broadcasting the second-stage divisions; and broadcasting the processed second-stage divisions.

In an embodiment, the method further comprises the steps of: partitioning the second output into two third-stage divisions; processing each third-stage division into a processed third-stage division; and combining the processed third-stage divisions into a third output.

In an embodiment, the step of partitioning the second output comprises partitioning the second output into three or more third-stage divisions.

In an embodiment, the method further comprises the steps of: broadcasting the second-stage divisions; and broadcasting the processed second-stage divisions.

In an embodiment, the steps of partitioning, processing and combining are coordinated by a server.

According to one aspect of this disclosure, there is provided a module comprising: a computing device for: partitioning a transformer input into two divisions, transmitting each of the divisions, and receiving processed divisions; and two transformer processing units, each for: receiving a division from the computing device, processing the division into a processed division, and sending the processed division to the computing device.

In an embodiment, the computing device is for partitioning the transformer input into three or more divisions.

In an embodiment, the module comprises three or more transformer processing units.

In an embodiment, the computing device is for broadcasting each of the divisions to the transformer processing units.

In an embodiment, each of the transformer processing units is for broadcasting the processed division.

In an embodiment, the computing device is a server.

In an embodiment, each of transformer processing units is an edge device.

In an embodiment, the computing device is for activating the transformer processing devices.

In an embodiment, the computing device is for deactivating the transformer processing devices.

In an embodiment, the module is for one or more of a smart phone application, a home automation device, an imaging application and a surveillance system.

### BRIEF DESCRIPTION OF THE DRAWINGS

For a more complete understanding of the disclosure, reference is made to the following description and accompanying drawings, in which:

FIG. 1 is a schematic diagram of a transformer workflow using a naïve partition method;

FIG. 2 is an schematic diagram illustrating acceleration of a convolutional neural network;

FIG. 3 is a block diagram illustrating a module for accelerating a transformer and some workflow in accordance with representative embodiments of the present disclosure;

FIG. 4 is a block diagram of a method for accelerating a transformer in accordance with representative embodiments of the present disclosure;

FIG. 5 is a schematic diagram of a computer network system for performing transformer computations, according to some embodiments of this disclosure;

FIG. 6 is a schematic diagram showing a simplified hardware structure of a computing device of the computer network system shown in FIG. 5; and

FIG. 7 a schematic diagram showing a simplified software architecture of a computing device of the computer network system shown in FIG. 5.

Throughout the appended drawings, like features are identified by like reference numerals.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

Transformer models are deep learning models for sequence-to-sequence learning using self-attention mechanisms and differentially weighing the significance of different elements of an input data. Transformer models generally comprise encoders and decoders, which are often collectively referred as transformer layer(s) as they share similar computation patterns. Two important components of transformer layers are multi-head self-attention mechanisms and position-wise feed-forward networks.

Transformer models are used in a wide variety of applications. However, their significant computational-resource requirements often pose challenges when deployed in computationally resource-constrained devices such as edge devices. In some embodiments disclosed herein, inference computations of transformer models are distributed among multiple edge devices to accelerate the speed of inference computations. As the self-attention mechanism of inference computations are generally the most time-consuming operation, consideration is directed towards self-attention mechanisms specifically.

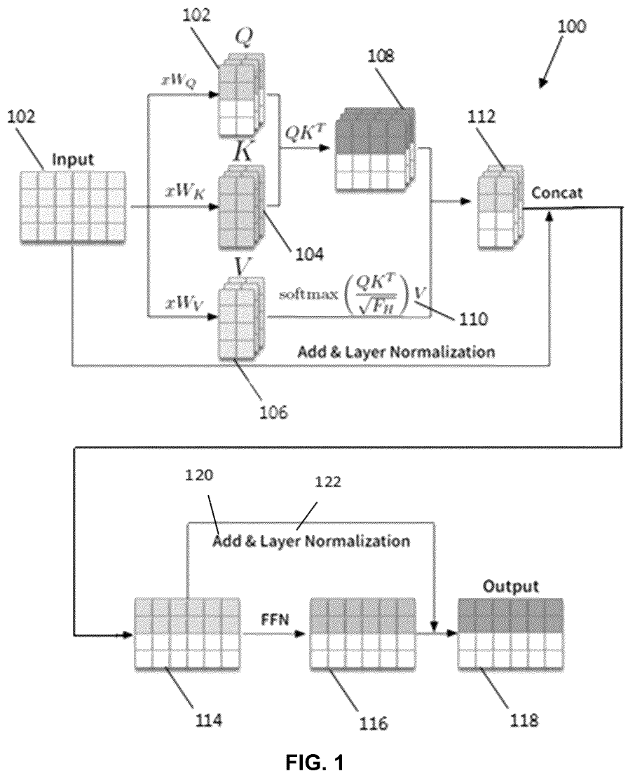

FIG. 1 illustrates the workflow of a transformer model 100 using a naïve partition method. Referring to FIG. 1, the transformer model 100 receives an input 102 which may be considered raw data for processing by a first layer of multiple layers of the transformer model 100. The input 102 may be denoted by x∈ [symbol] ^{N×F} where input x has length N and feature dimensionality F. The first layer generally comprises a multi-head self-attention mechanism which comprises a query (Q) computation 102, a key (K) computation 104, and a value (V) computation 106. The self-attention mechanism may project input 102 x into three computation matrices Q,K,V∈ [symbol] ^{N×F}^{_{H}} with learnable attention weights W_{Q}, W_{K}, W_{V}∈ [symbol] ^{F×F}^{_{H}}, where F_{H i}s the dimension of the attention features. More specifically, the query computation 102 may be represented by the following expression: Q=xW_{Q}. The key computation 104 may be represented by the following expression: Q=xW_{K}. The value computation 106 may be represented by the following expression: Q=xW_{V}. After computing Q, K and V, attention may be computed using the following expression at 110:

$$A t t n ( Q , K , V ) = softmax ( \frac{{QK}^{T}}{\sqrt{{F}_{H}}} ) V \qquad ( 1 )$$

The term Attn(Q, K, V) represents the calculation of the attention with inputs of Q, K and V. Attention is an expression indicating which parts of the input 102 should be performed with either higher or lower priority. Again, FH represents the dimensions of the attention features or matrices. Softmax( ) is an activation function that maps output features 118 to a value between 0 and 1, which may be viewed as a probability value. Rather than performing a single self-attention function, the transformer architecture may utilize a multi-head attention design wherein the transformer model attends to data at different representation spaces. Referring to the above attention function (Attn(Q, K, V)), the attention function is calculated multiple times with corresponding Q, K, and V values that are computed using different W_{Q}, W_{K}, W_{V} weights.

There are H different sets of learned attention weights to be applied independently to input x, where H>1 represents the number of attention heads. The multi-head self-attention mechanism splits an input into H heads. The output related to each of these H independent self-attention heads are concatenated by a concatenation operation and the combined output may be represented with the following expression:

$$MultiHead ( x ) = C o n c a t ( {A}^{1} ( x ) , … , {A}^{H} ( x ) ) {W}_{O} . \qquad ( 2 )$$

$$where$$

$${A}^{i} ( x ) = A t t n ( {xW}_{Q}^{i} , {xW}_{K}^{i} , {xW}_{V}^{i} ) \qquad ( 3 )$$

The output MultiHead(x) has the same dimensions as the input x, which permits the transformer to apply a residual link to add them together. Concat( ) represents the concatenation operation and W_{O} represents the weight for projection.

A layer normalization operation may be performed as a technique to normalize the input. The normalized input is then processed by a position-wise feed-forward network (FFN) with two linear transformations and an activation function, represented by the following expression FFN(x)=Act (xW₁+b₁)W₂+b₂, wherein W₁ and W₂ are learnable weights, and b₁ and b₂ are learnable biases for the linear transformation and Act( ) represents an activation function.

The FFN further comprises a residual connection also adopting the residual connection represented by Add 120 and layer normalization 122 in FIG. 1 to generate the final outputs of a transformer layer.

Most operations (for example, FFN, addition, concatenation, and layer normalization) performed in a transformer model are position dependent.

The query computation may be partitioned for, for example, distributing processing among edge devices.

In some embodiments disclosed herein, modules and methods use a position-wise partition method for transformer models. A position-wise partition method is used because most of the operations in the transformer layers such as FFN and layer normalizations are position specific. That is, each device computes a part of the output at different positions.

For example, the first two rows of the output in FIG. 1 are computed for the first and second positions. The same computation procedure may be followed while some parts of the matrices are not required.

In attention computations of Equation (3), the matrix Q may be replaced with a sub-matrix Qₚ=xₚW_{Q}, where p represents a partitioned query computation, and xₚ denotes the input partition at the corresponding positions. Then, the corresponding positions may be obtained for the multi-head self-attention mechanism. The result may be fed into the remaining part of the transformer layer to obtain the desired output partition as they are position-wise operations. This way, a workload of a single transformer layer may be partitioned into pieces and assigned to different devices.

While the query computation may be distributed, it may have at least two issues. First, while the output of one transformer layer may be partitioned and computed using different devices, the subsequent layer still requires the whole matrix as input, which means that the output partitions needs to be synchronized among all the devices between layers. This is because the transformer requires the output “attends” to each position by design. Second, even with acceptable output synchronization, efficient distribution of the inference workload must be adapted due to the “global” receptive field of self-attention. Although only a part of the output is needed, K and V still need to be computed as a whole no matter how small the partition size is.

In some embodiments disclosed herein, modules and methods provide accelerated trained transformers at inference time without negatively impacting performance in terms of accuracy. Calculations in a transformer are performed position specific as most operations of a conventional transformer, except for the self-attention function which is performed on each position separately. The inference workload may be partitioned such that the layer output of different positions may be calculated simultaneously using different devices to facilitate acceleration. Further, a data synchronization phase may be used between layers to address the requirement that the whole input is required at each stage.

As the computational cost associated with a multi-head self-attention mechanism is equal to the sum of each attention head, the computational cost of a single self-attention head is described in the following which may be easily extended to the computational cost of the multi-head self-attention mechanism. The expression xₚ∈ [symbol] ^{P×F} represents the input partition corresponding to the positions of the output partition Aₚ(x). Therefore, the naïve partition method to compute Aₚ(x) may be condensed into the following equation (A):

$${A}_{p} ( x ) = softmax ( \frac{( {x}_{p} {W}_{Q} ) {( {xW}_{K} )}^{T}}{\sqrt{{F}_{H}}} ) ( {xW}_{V} ) \qquad ( 4 )$$

In the above equation for Aₚ(x), the parenthesis indicates the order of computation, that is, computing Q, K, and I matrices in advance. Matrix multiplication is the main operation of self-attention as it relates to calculating computational complexity. Therefore, the number of floating operations, denoted by Γ(•) may be used to measure the computational complexity. For example, with x∈ [symbol] ^{N×F} and W_{Q}∈ [symbol] ^{F×F}^{_{H}}, the computation complexity of Q 32 xW_{Q} may be measured by Γ(xW_{Q})=N×F×F_{H}=NFF_{H} and the following method may be used to calculate the computational complexity:

Given input x∈ [symbol] ^{N×F} and input partition xₚ∈ [symbol] ^{P×F} where

$$P = \frac{N}{K} ,$$

attention weights W_{Q}, W_{K}, W_{V}∈ [symbol] ^{F×F}^{_{H}} the computation complexity of Aₚ(x) is:

$$\begin{matrix}( Equation ( 4 ) ) & \\ Γ = \frac{{NFF}_{H} + 2 {N}^{2} {F}_{H}}{K} + 2 {NFF}_{H} + O ( \frac{N}{K} {F}_{H} ) = O ( \frac{1}{K} ) + 2 {NFF}_{H} & ( 5 )\end{matrix}$$

In the above method relating to Γ(Equation (4)), x has dimension of N×F, xₚ has dimension of P×F, and P equals to N/K, which means the input x is partitioned into K portions. The constant term 2NFF_{H} prevents a naïve partition method from achieving suitable linear acceleration as it means that no matter how small partitions are or how many devices are available for performing computations, the K and V matrices are unchanged and are potentially computational bottlenecks.

To obviate the need for compute K and V in advance, the order of matrix multiplication may be changed such that K and V are computed when required. For example, V does not need to be computed in advance and W_{V} may be left until last, which may reduce computational complexity under certain conditions. It is unnecessary to compute K=xW_{K} in advance to obtain OₚK^{T} and the expression may be expanded to the following:

$${Q}_{p} {K}^{T} = ( {x}_{p} {W}_{Q} ) {( {xW}_{K} )}^{T} = {x}_{p} {W}_{Q} {W}_{K}^{T} x \qquad ( 6 )$$

The above computations involve four matrices and may be computed in at least five different orders, where computing Q and K in advance is only one of them. For ease of description, define

$$S {=}^{Δ} softmax ( \frac{( {x}_{p} {W}_{Q} ) {( {xW}_{K} )}^{T}}{\sqrt{{F}_{H}}} ) ,$$

where S∈ [symbol] ^{P×N}, then the following two equivalent methods may be used to compute Aₚ(x):

### Method I

$${A}_{p} = S ( {xW}_{v} ) , \qquad ( 7 )$$

that is, calculating xWᵥ first, then calculating the multiplication of S and xWᵥ. The computation complexity is PNF_{H}+NFF_{H}.

### Method II

$${A}_{p} = ( Sx ) {W}_{v} , \qquad ( 8 )$$

that is, calculating Sx first, then calculating the multiplication of Sx and Wᵥ. The computation complexity is PNF+PFF_{H}.

Using the two methods, the five different orders for computing Q and K become ten different orders in total to calculate Aₚ(x). The different possibilities may be compared to determine the optimal method to compute the matrices. While determining the optimal method may generally add computational overhead, in the context of transformer models, the feature size and shape of attention weights are fixed for a given layer, which leaves input and partition size as the variables.

In fact, the order of matrix multiplication may be changed so that K and V do not need to be computed in advance, and they may only be computed when needed to achieve the best optimization. The following conclusion describes the relationship between optimal computational order and input settings and provides a guidance of the choice between methods I and II:

```
    Given input x ∈ [symbol]  ^{N×F}, input partition
xₚ ∈ [symbol]  ^{P×F}, attention weights W_{Q}, W_{K}, W_{V} ∈ [symbol]  ^{F×F}^{_{H}}, and F = HF_{H}
where H is the number of anention heads,
  $1. when \frac{1}{P} - \frac{1}{N} \leq \frac{F - {F}_{H}}{F {F}_{H}} , Equation 3 achieves the lowest$
    computation complexity;
  $2. when \frac{1}{P} - \frac{1}{N} > \frac{F - {F}_{H}}{F {F}_{H}} , the following equation$
    achieves the lowest computation complexity
    ${A}_{p} ( x ) = ( softmax ( \frac{( ( {x}_{p} {W}_{Q} ) {W}_{K}^{T} ) {x}^{T}}{\sqrt{{F}_{H}}} ) x ) {W}_{V}$
```

According to the above conclusion, there are two options among all possible computation orders. Since attention weights W_{Q} and W_{K} are constants during inference computations, W_{Q}W_{K}^{T} may be calculated in advance such that there will only be the matrix calculations for Aₚ(x). While this is generally true for single-head attention mechanisms, for multi-head attention mechanisms, W_{Q}W_{K}^{T}∈ [symbol] ^{F×F} becomes much larger than W_{Q}, W_{K}∈ [symbol] ^{P×F}^{_{H}}.

Therefore, the most efficient way to compute inference may be determined based on how many devices are available. Compared to the naïve partition method, in some embodiments of modules and methods disclosed herein, the constant term relevant to the bottleneck described above is avoided.

In some embodiments, a transformer layer may be partitioned wherein a whole input sequence x and a range of desired output partitions p, which may be specified by the position, are used as input for generating a corresponding output partition of the transformer layer. Based on the input and layer settings, the most efficient method may be selected and applied to each head of the self-attention function. The attention output may be directly fed into the subsequent position-wise FFN and layer normalizations to generate a desired output partition. This is illustrated by the following method:

```
Input: x ∈ [symbol]  ^{N×F}, desired partitions p
Output: Transformer layer output partition Tₚ(x)
P ← partition length
for each head of attention i = 1, . . . , H do
  $if \frac{1}{P} - \frac{1}{N} > \frac{F - {F}_{H}}{F {F}_{H}} then$
    $Compute {A}_{p}^{( i )} ( x ) with {A}_{p} ( x ) = ( softmax ( \frac{( ( {x}_{p} {W}_{Q} ) {W}_{K}^{T} ) {x}^{T}}{\sqrt{{F}_{H}}} ) x ) {W}_{V}$
  else
    $Compute {A}_{p}^{( i )} ( x ) with {A}_{p} ( x ) = softmax ( \frac{( {x}_{p} {W}_{Q} ) {( {xW}_{K} )}^{T}}{\sqrt{{F}_{H}}} ) ( {xW}_{V} )$
  end if
end for
R ← Concat(Aₚ^{(I)}(x), . . . , Aₚ^{(H)}(x))W_{O}
Y ← LayerNorm(R + xₚ)
Tₚ(x) ← LayerNorm(Y + FFN(Y))
return Tₚ(x)
```

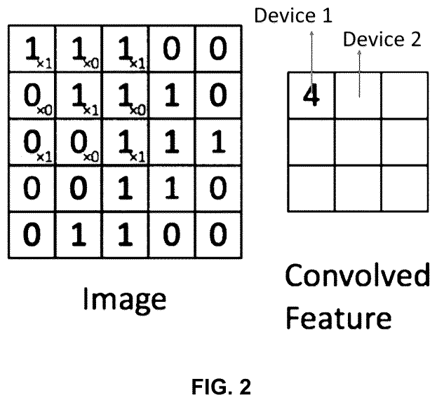

Convolutional neural networks (CNNs) are artificial intelligence (AI) models comprising shared-weight architectures of convolution kernels or filters that are applied to input features to produce translation-equivariant responses known as feature maps. Referring to FIG. 2, an input image is convolved with convolution kernels or filters to produce a convolved feature map output. Some existing systems and methods using CNNs comprise distributed architectures, where workload is distributed among multiple devices such as edge devices. These distributed architectures are directed to CNNs which are more suitable for such distribution. Specifically, the output of a certain CNN layer is obtained by convolving the same kernel or filter to different portions of the input feature maps. This property is known as partial receptive field. Therefore, convolutional operations may be decomposed and distributed to various edge devices and may be proceeded in parallel. This is illustrated in FIG. 2 with edge devices indicated as Device 1 and Device 2.

Unfortunately, the structural characteristics of the transformer makes it unsuitable to reuse existing solutions for distributed inference designed specifically for CNNs. First, transformers has no partial but a “global” receptive field, wherein each layer requires, as input, all of the output values of a previous layer. For transformer models where computations are distributed among device, this requires synchronization of inputs and outputs between layers. Regardless, with current implementations of transformer models, computations of the self-attention layer, being generally the most time consuming in a transformer model, cannot be efficiently distributed. Second, such solutions requires fixed input sizes, but transformers allow arbitrarily long or short sequences as the transformer model allows.

Respecting to the self-attention layer, the order of computation significantly affects the computational complexity. In some embodiments of modules and methods disclosed herein, computation of the self-attention function may be adaptively conducted based on an analysis on the relationship between the computation complexity and the layer settings, including the partition size, input size, and feature dimensions.

In some embodiments disclosed herein, the inference workload is partitioned such that the layer output at different positions may be computed simultaneously using different devices such as edge devices to accelerate the computations. To manage workflow, the transformer model is considered a stack of transformer layers where the output of one layer is directly fed into the next layer. The output for a single layer T(x) may be obtained in parallel from different devices followed by concatenation, addition, and layer normalization. However, as next layer still requires the whole output from previous layer as input, output partitions must be synchronized among all the devices to obtain complete features between layers.

The inference data x and a partitioning method is used as input, where the partition method indicates how the workload is distributed among the devices. When the inference request comes, data x is distributed to all devices, then for each transformer layer, each device computes the assigned output partition, and sends the result to all peer devices for synchronization. By the end of a layer, all devices may assemble the full output of the layer, which becomes the input for the next layer, and start a new round of computation. This procedure repeats until the end of the model.

The partition method of K devices may be express as a list [p₁. . . , pₖ], where pᵢ indicates the position that the i-th device is responsible to compute. The partition method satisfies the following conditions:

$$\begin{matrix}{x}_{{p}_{i}} ⋂ {x}_{{p}_{j}} = ∅ , ∀ i \neq j , \\ {⋃}_{i = 1 , ... , k} {x}_{{p}_{j}} = x .\end{matrix}$$

The first condition ensures that no overlapping among the positions are assigned to different devices to prevent redundant computations. The second condition ensures that all positions are covered during inference. For example, a ratio-based partition method may be used, wherein each device computes a fixed portion such as 1/K of the input sequence.

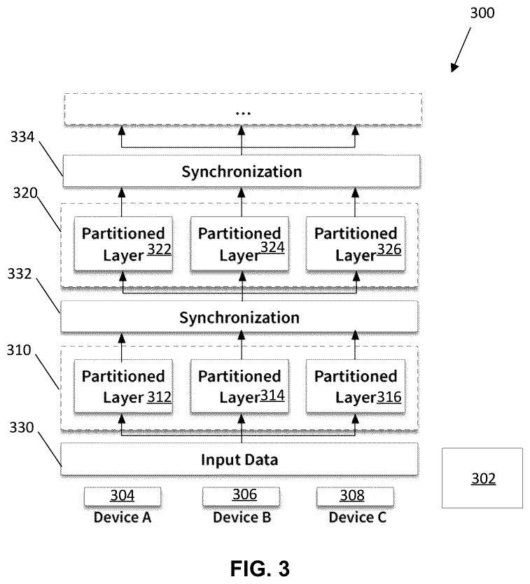

FIG. 3 illustrates a module 300 for accelerating a transformer with some workflow in accordance with some representative embodiments of the present disclosure. The module 300 comprises a computing device 302 and transformer processing units including a first transformer processing unit 304 (Device A), a second transformer processing unit 306 (Device B), and a third transformer processing unit 308 (Device C). The computing device 302 is used for partitioning a transformer input 330 into two or more divisions, transmitting each of the divisions and receiving processed divisions. Each of the transformer processing units 304 or 306 or 308 is for receiving a division from the computing device 302, processing the division into the processed division, and sending the processed division to the computing device. At the first layer 310, the input data 330 is partitioned into three first-stage divisions 312 and 314 and 316. Each of the three first-stage divisions 312 and 314 and 316 is processed by one of the transformer processing units 304 or 306 or 308 to provide three processed first-stage divisions, which are synchronized by the computing device 302 at a synchronization step 332 to provide a first output. At the second layer 320, the first output is partitioned into three second-stage divisions 322 and 324 and 326. Each of the three second-stage divisions 322 and 324 and 326 is processed by one of the transformer processing units 304 or 306 or 308 to provide three processed second-stage divisions, which are synchronized by the computing device 302 at a synchronization step 334 to provide a second output. This process may be repeated for additional stages. After the divisions are processed into processed divisions, they may be broadcast over the entire system by the appropriate transformer processing unit 304 or 306 or 308. While the exemplary embodiment described comprises three transformer processing units and three divisions per stage, not all of the transformer processing units need to be used. For example, at the first-stage, the input 330 may be partitioned into two first-stage divisions 312 and 314 and the second-stage may comprise three second-stage divisions 322 and 324 and 326.

The computing device 302 may be a server and the transformer processing units 304 or 306 or 308 may be edge devices. Each of the computing device 302 and the transformer processing units 304 or 306 or 308 may comprise a memory for storing computer-executable instructions implementing above-described methods and for storing data, a processor or processing circuit for executing the computer-executable instructions stored in the memory, and a network interface for communicating with each other. The computing device 302 and the transformer processing units 304 and 306 and 308 may be configured such that the computing device 302 may activate and deactivate the transformer processing units 304 and 306 and 308 as appropriate. The module 300 may be for smart phone applications, home automation devices, imaging applications or surveillance systems.

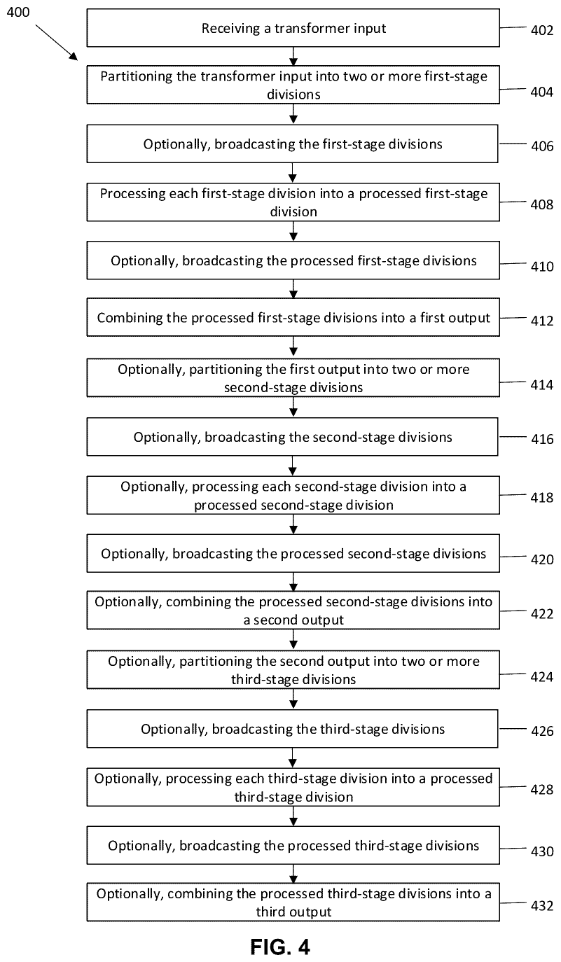

FIG. 4 is a flowchart showing the steps of a method 400, according to some embodiments of the present disclosure. The method 400 begins with receiving a transformer input (step 402). At step 404, the transformer input is partitioned into two or more first-stage divisions. Optionally, at step 406, the first-stage divisions are broadcast. At step 408, each first-stage division is processed into a processed first-stage division. Optionally, at step 410, the processed first-stage divisions are broadcast. At step 412, the processed first-stage divisions are combined into a first output. Optionally, at step 414, the first output is partitioned into two or more second-stage divisions. Optionally, at step 416, the second-stage divisions are broadcast. Optionally, at step 418, each second-stage divisions is processed into a processed second-stage division. Optionally, at step 420, the processed second-stage divisions are broadcast. Optionally, at step 422, the processed second-stage divisions are combined into a second output. Optionally, at step 424, the second output is partitioned into two or more third-stage divisions. Optionally, at step 426, the third stage divisions are broadcast. Optionally, at step 428, each third-stage division is processed into a processed third-stage division. Optionally, at step 430, the processed third-stage divisions are broadcast. Optionally, at step 432, the processed third-stage divisions are combined into a third output.

As used herein, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer- readable storage devices or media.

As used herein, the module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module executes a process for performing. Herein, a process has a general meaning equivalent to that of a method, and does not necessarily correspond to the concept of computing process (which is the instance of a computer program being executed). More specifically, a process herein is a defined method implemented using hardware components for process data. A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the transformer process disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. The module may read the computer-executable code from the storage devices and execute the computer-executable code to perform the transformer processes.

Alternatively, the transformer process disclosed herein may be implemented as one or more hardware structures having necessary electrical and/or optical components, circuits, logic gates, integrated circuit (IC) chips, and/or the like.

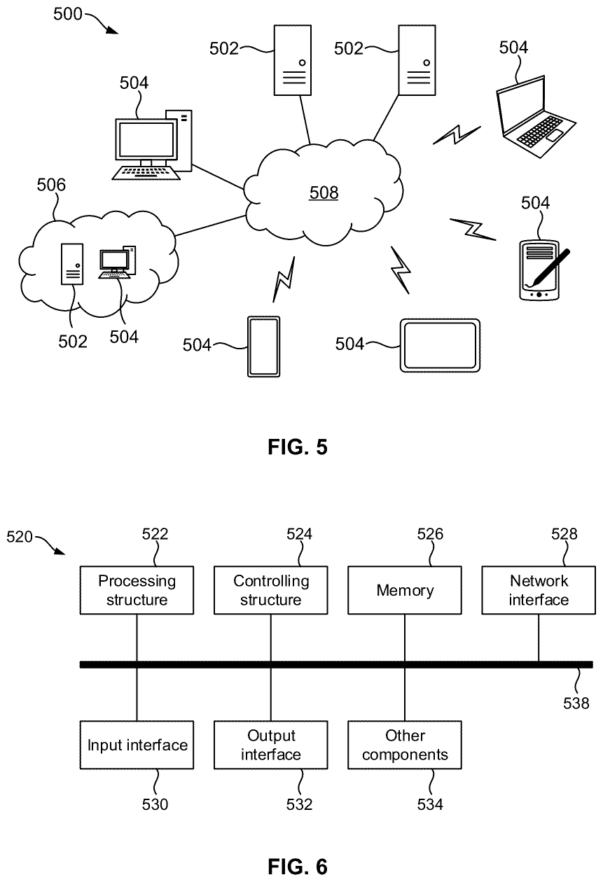

Turning now to FIG. 5, a computer network system for performing transformer computation is shown and is generally identified using reference numeral 500. In these embodiments, the system 500 is configured for performing transformer computations

As shown in FIG. 5, the system 500 comprises one or more server computers 502, a plurality of client computing devices 504, and one or more client computer systems 506 functionally interconnected by a network 508, such as the Internet, a local area network (LAN), a wide area network (WAN), a metropolitan area network (MAN), and/or the like, via suitable wired and wireless networking connections. While in some embodiments, edge devices as described herein refer to client computing devices 504 and/or client computer systems 506, devices and edge devices as described herein may comprise any one or more of the server computers 502, the client computing devices 504, and/or the client computer systems 506, as may be appropriate in a particular application.

The server computers 502 may be computing devices designed specifically for use as a server, and/or general-purpose computing devices acting server computers while also being used by various users. Each server computer 502 may execute one or more server programs.

The client computing devices 504 may be portable and/or non-portable computing devices such as laptop computers, tablets, smartphones, Personal Digital Assistants (PDAs), desktop computers, smart devices, and/or the like. Each client computing device 504 may execute one or more client application programs which sometimes may be called “apps”.

Generally, the computing devices 502 and 504 comprise similar hardware structures such as hardware structure 520 shown in FIG. 6. As shown, the hardware structure 520 comprises a processing structure 522, a controlling structure 524, one or more non-transitory computer-readable memory or storage devices 526, a network interface 528, an input interface 530, and an output interface 532, functionally interconnected by a system bus 538. The hardware structure 520 may also comprise other components 534 coupled to the system bus 538.

The processing structure 522 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARMR microprocessors (ARM is a registered trademark of Arm Ltd., Cambridge, UK) manufactured by a variety of manufactures such as Qualcomm of San Diego, California, USA, under the ARM® architecture, or the like. When the processing structure 522 comprises a plurality of processors, the processors thereof may collaborate via a specialized circuit such as a specialized bus or via the system bus 538.

The processing structure 522 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 522 comprises necessary circuitry implemented using technologies such as electrical and/or optical hardware components for executing transformer related processes.

For example, the processing structure 522 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 522, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 522 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 522 is usually of no use without meaningful firmware and/or software.

Of course, those skilled the art will appreciate that a process or a function (and thus the processor 502) may be implemented using other technologies such as analog technologies.

Referring back to FIG. 5, the controlling structure 524 comprises one or more controlling circuits, such as graphic controllers, input/output chipsets and the like, for coordinating operations of various hardware components and modules of the computing device 502/504.

The memory 526 comprises one or more storage devices or media accessible by the processing structure 522 and the controlling structure 524 for reading and/or storing instructions for the processing structure 522 to execute, and for reading and/or storing data, including input data and data generated by the processing structure 522 and the controlling structure 524. The memory 526 may be volatile and/or non-volatile, non-removable or removable memory such as RAM, ROM, EEPROM, solid-state memory, hard disks, CD, DVD, flash memory, or the like.

The network interface 528 comprises one or more network modules for connecting to other computing devices or networks through the network 508 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 530 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 530 may be a physically integrated part of the computing device 502/504 (for example, the touch-pad of a laptop computer or the touch-sensitive screen of a tablet), or may be a device physically separate from, but functionally coupled to, other components of the computing device 502/504 (for example, a computer mouse). The input interface 530, in some implementation, may be integrated with a display output to form a touch-sensitive screen or touch-sensitive whiteboard.

The output interface 532 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 532 may be a physically integrated part of the computing device 502/504 (for example, the display of a laptop computer or tablet), or may be a device physically separate from but functionally coupled to other components of the computing device 502/504 (for example, the monitor of a desktop computer).

The computing device 502/504 may also comprise other components 534 such as one

or more positioning modules, temperature sensors, barometers, inertial measurement unit (IMU), and/or the like.

The system bus 538 interconnects various components 522 to 534 enabling them to transmit and receive data and control signals to and from each other.

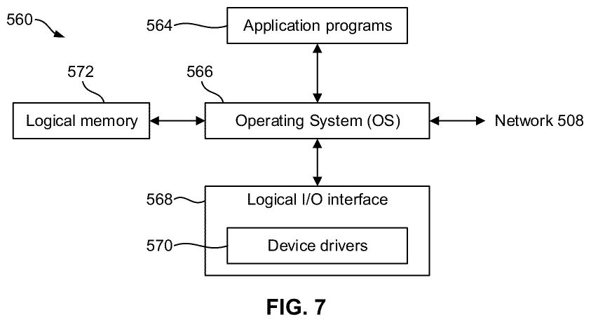

FIG. 7 shows a simplified software architecture 560 of the computing device 502 or 504. The software architecture 560 comprises one or more application programs 564, an operating system 566, a logical input/output (I/O) interface 568, and a logical memory 572. The one or more application programs 564, operating system 566, and logical I/O interface 568 are generally implemented as computer-executable instructions or code in the form of software programs or firmware programs stored in the logical memory 572 which may be executed by the processing structure 522.

The one or more application programs 564 executed by or run by the processing structure 522 for performing various tasks.

The operating system 566 manages various hardware components of the computing device 502 or 504 via the logical I/O interface 568, manages the logical memory 572, and manages and supports the application programs 564. The operating system 566 is also in communication with other computing devices (not shown) via the network 508 to allow application programs 564 to communicate with those running on other computing devices. As those skilled in the art will appreciate, the operating system 566 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 502 and 504 of the image-sanitization system 500 may all have the same operating system, or may have different operating systems.

The logical I/O interface 568 comprises one or more device drivers 570 for communicating with respective input and output interfaces 530 and 532 for receiving data therefrom and sending data thereto. Received data may be sent to the one or more application programs 564 for being processed by one or more application programs 564. Data generated by the application programs 564 may be sent to the logical I/O interface 568 for outputting to various output devices (via the output interface 532).

The logical memory 572 is a logical mapping of the physical memory 526 for facilitating the application programs 564 to access. In this embodiment, the logical memory 572 comprises a storage memory area that may be mapped to a non-volatile physical memory such as hard disks, solid-state disks, flash drives, and the like, generally for long-term data storage therein. The logical memory 572 also comprises a working memory area that is generally mapped to high-speed, and in some implementations volatile, physical memory such as RAM, generally for application programs 564 to temporarily store data during program execution. For example, an application program 564 may load data from the storage memory area into the working memory area, and may store data generated during its execution into the working memory area. The application program 564 may also store some data into the storage memory area as required or in response to a user's command.

In a server computer 502, the one or more application programs 564 generally provide server functions for managing network communication with client computing devices 504 and facilitating collaboration between the server computer 502 and the client computing devices 504. Herein, the term “server” may refer to a server computer 502 from a hardware point of view or a logical server from a software point of view, depending on the context.

As described above, the processing structure 522 is usually of no use without meaningful firmware and/or software. Similarly, while a computer system such as the system 500 may have the potential to perform various tasks, it cannot perform any tasks and is of no use without meaningful firmware and/or software. As described in more detail herein, the system 500 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

Embodiments have been described above in conjunctions with aspects of the present invention upon which they may be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Although the present invention has been described with reference to specific features and embodiments thereof, it is evident that various modifications and combinations may be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
receiving a transformer input;
partitioning the transformer input into two first-stage divisions;
processing each first-stage division into a processed first-stage division; and
combining the processed first-stage divisions into a first output.

2. The method of claim 1, wherein the step of partitioning the transformer input comprises partitioning the transformer input into three or more first-stage divisions.

3. The method of claim 1, further comprising the steps of:
broadcasting the first-stage divisions; and
broadcasting the processed first-stage divisions.

4. The method of claim 1, further comprising the steps of:
partitioning the first output into two second-stage divisions;
processing each second-stage division into a processed second-stage division; and
combining the processed second-stage divisions into a second output.

5. The method of claim 4, wherein the step of partitioning the first output comprises partitioning the first output into three or more second-stage divisions.

6. The method of claim 4, further comprising the steps of:
broadcasting the second-stage divisions; and
broadcasting the processed second-stage divisions.

7. The method of claim 4, further comprising the steps of:
partitioning the second output into two third-stage divisions;
processing each third-stage division into a processed third-stage division; and
combining the processed third-stage divisions into a third output.

8. The method of claim 7, wherein the step of partitioning the second output comprises partitioning the second output into three or more third-stage divisions.

9. The method of claim 7, further comprising the steps of:
broadcasting the second-stage divisions; and
broadcasting the processed second-stage divisions.

10. The method of claim 1, wherein the steps of partitioning, processing and combining are coordinated by a server.

11. A module comprising:
a computing device for:
partitioning a transformer input into two divisions,
transmitting each of the divisions, and
receiving processed divisions; and
two transformer processing units, each for:
receiving a division from the computing device,
processing the division into a processed division, and
sending the processed division to the computing device.

12. The module of claim 11, wherein the computing device is for partitioning the transformer input into three or more divisions.

13. The module of claim 11 comprising three or more transformer processing units.

14. The module of claim 11, wherein the computing device is for broadcasting each of the divisions to the transformer processing units.

15. The module of claim 11, wherein each of the transformer processing units is for broadcasting the processed division.

16. The module of claim 11, wherein the computing device is a server.

17. The module of claim 11, wherein each of transformer processing units is an edge device.

18. The module of claim 11, wherein the computing device is for activating the transformer processing devices.

19. The module of claim 11, wherein the computing device is for deactivating the transformer processing devices.

20. The module of claim 11, wherein the module is for one or more of a smart phone application, a home automation device, an imaging application and a surveillance system.
